(19) United States
(12) Patent Application Publication
(10) Pub. No.: US 2018/0247598 A1
(43) Pub. Date: Aug. 30, 2018

(54) WRITEABLE ELECTROPHORETIC DISPLAY AND STYLUS CONFIGURED TO WRITE ON ELECTROPHORETIC DISPLAY WITH LIGHT AND ELECTROMAGNETIC SENSING

(71) Applicant: E INK CORPORATION, Billerica, MA (US)

(72) Inventors: Sunil Krishna SAINIS, Melrose, MA (US); Richard J. PAOLINI, JR., Framingham, MA (US); Ana L. LATTES, Newton, MA (US); Stephen J. TELFER, Arlington, MA (US); Seth J. BISHOP, Framingham, MA (US)

(21) Appl. No.: 15/907,447

(22) Filed: Feb. 28, 2018

Related U.S. Application Data
(60) Provisional application No. 62/464,422, filed on Feb. 28, 2017.

(51) Int. Cl. G09G 3/34; G02F 1/167; G02F 1/1343; G02F 1/1333; G02F 1/1368; G02F 1/1335; G02F 1/1362; G02F 1/135; G06F 3/0354; G06F 3/044; G06F 3/046

(52) U.S. Cl. CPC G09G 3/344; G09G 2310/0272; G02F 1/13439; G02F 1/13338; G02F 1/1368; G02F 1/133514; G02F 1/136286; G02F 1/135; G06F 3/03545; G06F 3/044; G06F 3/046; G02F 2001/1676; G02F 2202/28; G02F 2202/103; G02F 1/167

(57) ABSTRACT

A writeable display medium incorporating light-sensitive semiconductors into the thin film transistors (TFTs), and incorporating a long-pass optical filter to provide a narrow window of wavelengths that can be used to cause the TFTs to switch states when suitably biased. As a light-emitting stylus is moved over the display, the light will change the state of the TFTs, resulting in a nearly instantaneous state change in the display (i.e., white to black). Accordingly, writeable display media of the invention do not suffer from the writing latency that is experienced with many writeable tablet systems.

### RELATED APPLICATIONS

This application claims priority to U.S. Provisional Application No. 62/464,780, filed Feb. 28, 2017, which is incorporated herein by reference in its entirety.

### BACKGROUND OF INVENTION

This invention relates to writable electronic tablets, which allow users to take notes, draw figures, and edit documents electronically. In some embodiments, the writable electronic tablets record the writings/drawings and convert them into a digital format that is easily saved, recalled, and shared.

A number of LCD-based tablets are commercially-available that have the ability to record a user's writing, drawing, or mark-up of documents. For example, the Microsoft SURFACE® Pro 4 (Microsoft Corporation, Redmond, Wash.) comes with a stylus (SURFACE PEN®) that allows a user to take notes, draw, and mark-up documents that are viewed on the LCD touch screen. The position of the stylus is tracked by broadcasting a signal from the stylus tip to the capacitive touch screen of the tablet, whereby a proximity-sensing algorithm is used to determine the location of the stylus. Other LCD-based tablets, such as the Sony VAIO LX900 (Sony Corporation, Tokyo, Japan) use the digitizing technology of Wacom (Wacom Co. Ltd., Kazo, Japan) whereby the stylus tip (including an inductive loop) is located by an energized digitizing layer located behind the LCD display. The digitizing layer typically comprises a grid of overlapping electrodes adjacent a magnetic film. The stylus head in the Wacom system includes an inductive coil, and the motion of the coil during writing can be translated into a position with respect to the grid defined by the electrodes in the digitizing layer.

A common complaint from users is that these LCD-based tablets do not provide a “paper-like” experience. First, because the LCD is power-hungry, the screen will typically go dark when the tablet is not in active use. This means that a user has to “wake up” the device to start writing, and often has to reawaken the device during a writing session because the device went “to sleep” while the user was listening to a speaker, or otherwise engaged in a different task. Secondly, the pen strokes do not feel or look like writing on paper because the texture, depth, and latency of the writing device is perceptible different that using a pen on real paper. Often when writing on an LCD display with a stylus, a user has the sense that he/she is dragging a plastic stick across a plate of glass. Furthermore, when using these types of electronic tablets, the writing has a “depth” into the viewing surface that is disorienting. The written words are not at the top surface interacting with the stylus, but rather disconnected from the stylus tip.

Alternate electronic writing devices have been constructed using light-reflective media, such as electrophoretic ink (E Ink Corporation, Billerica, Mass.). See, for example, the DPTS1™ from Sony (Sony Corporation, Tokyo, Japan). Electrophoretic ink solves many of the “sleeping” problem of LCD-based writing systems because the devices are always “on”. They consume far less power during the writing process so they don't need to go to sleep except when prompted by the user, and even after they are asleep they continue to display the writing. Additionally, because the electrophoretic ink is very close to the surface of the device, the pen response looks more like writing. The devices are also sunlight-readable, which makes it possible to use the device outdoors or in other bright-light environments. Some commercially-available electrophoretic ink devices, such as the ReMARKABLE™ tablet (REMARKABLE A.S., Oslo, Norway), also include high-friction surface materials that create a “feel” that is far more paper-like. While such friction materials can be included on LCD displays, the materials can interfere with the image quality of the LCD because the friction materials scatter the light emitted from the display.

Regardless of the format (LCD or electrophoretic ink), users of electronic (tablet) display writing systems typically experience distracting latency between stylus movement and image updates when writing. This latency is caused by the time that is required to sense the position of the stylus and update the image driver so that the movement of the stylus is accurately portrayed as writing/drawing on the screen. The latency is the additive delay of a series of steps such as sensing the position of the stylus, sending the position information to the display driver, processing the display change, and refreshing the display. In many cases, the position information is additionally saved to memory to allow the user to later recall the notes, and this saving step may add an additional small delay. In LCD-based systems, the latency is typically on the order of 60 ms. Many users find the latency to be distracting, and in some cases, the latency limits the speed that a user can take notes, draw, etc.

In addition to the sensing and saving the position information, there may be additional lag time associated with refreshing the image to show the writing. For example, electrophoretic ink systems often have latencies of at least 140 ms because of the additional time that it takes to drive the electrophoretic particles between image states after the update is sent to the pixels. In addition, the latency may vary depending upon what portion of the display is being updated. That is, the latency is different across the display surface because the display driver updates the scan lines in an orderly fashion. For example, the latency may be more noticeable when writing in the lower right-hand corner of the tablet versus the upper left-hand corner.

To counter the latency, many manufacturers use predictive algorithms to reduce the number of updates needed to capture the writing. These predictive algorithms may, for example, process the previous letters that were written and predict the next letters. The algorithms may also employ a rolling average to anticipate straight lines or use smoothing to account for fluctuations in stylus sensing. Nonetheless, such algorithms can result in unintended strokes being generated which can be just as distracting to a user as waiting for updates.

### SUMMARY OF INVENTION

The invention addresses several shortcomings of the prior art by providing a writeable display medium that is paper-like and allows nearly instantaneous text updates as the stylus is moved across the surface of the display. The writeable display medium includes a light-transmissive front electrode, an electrophoretic medium comprising charged particles that move in the presence of an electric field, an array of thin film transistors comprising light-sensitive semiconductors, a long pass optical filter, and a digitizing layer configured to locate a touch on the writeable display medium. The long pass filter will allow only certain wavelengths of light, e.g., longer than 550 nm, to cause the thin film transistors to actuate and the display state to update. The invention allows the display state to be controlled with a suitable long-wavelength light source without interference from ambient light, e.g., sunlight. Often the writeable display medium will be operatively coupled to a power source and a display driver, whereby the power is used to bias the thin film transistors so that the light source can address the display. The writeable display medium may also be coupled to memory that can be used to receive position information from the digitizing layer and to send the position information to the display driver. The writeable display medium is useable with digitizing layers, generally, so digitizing layers using either electromagnetic or capacitive sensing can be used with the invention.

The writeable display medium, described above, can be incorporated into a writeable system that includes a stylus. The stylus has A) a light source that is configured to interact with the light-sensitive thin-film transistors, and B) an electromagnetic or capacitive coupling element that allows the stylus to interact with the digitizing layer of the device. When the stylus is moved, light from the stylus causes various TFTs to change state, thereby causing the electrophoretic media to switch display configuration (e.g., white to black).

When the writeable display medium, described above, is updated, the thin film transistors (TFTs) are biased so that the incoming light from the stylus will be sufficient to alter the state of the TFTs and change the display state immediately. However, in some instances, it will be beneficial to only bias those TFTs that are in the immediate vicinity of the stylus. This can be achieved with dynamic feedback, whereby the sensed position of the stylus (i.e., through the digitizing backplane) is used to determine an area of the TFT array that will be biased, while the remainder of the TFT array is left in an unbiased state, and therefore less susceptible to accidental state change via spurious light. For example, a 10 TFT by 10 TFT square, centered on the position of the stylus, may be biased. Nonetheless, the size of the biased area may be increased to accommodate for density of TFTs or the speed of writing. For example a 100 TFT by 100 TFT square, centered on the position of the stylus, may be biased, or a 1000 TFT by 1000 TFT square, centered on the position of the stylus, may be biased. The biased area need not be a square, and could be a circle, ellipse, triangle, or some other shape. Often the biased area will be dynamically-updated so that the biased area will move across the area of the writing surface along with the stylus. In addition to updating the bias area, the same position information can be written to memory whereby the position information can be the basis for a global update of the written image and also be sent (via electronic format) to a file or another device, such as a phone, digital whiteboard, computer, secondary display, etc.

### BRIEF DESCRIPTION OF DRAWINGS

FIG. 1 is a general depiction of an electrophoretic medium, suitable for use in the invention;

FIG. 2 is a general depiction of a thin film transistor (TFT) array, suitable for use in the invention;

FIG. 3 depicts prior art thin film transistors that are coated with a light-absorbing layer to improve performance in an electrophoretic display;

FIG. 4 illustrates writing to a writeable display medium of the invention with a stylus;

FIG. 5 illustrates writing to a writeable display medium of the invention with a stylus;

FIG. 6 illustrates a system including writeable display medium and a stylus;

FIG. 7 illustrates an embodiment of a stylus suitable for use with a writeable display medium of the invention;

FIG. 8 illustrates an embodiment of a stylus suitable for use with a writeable display medium of the invention;

FIG. 9 is a flow chart illustrating how a writing area of a TFT array may be dynamically updated as a stylus is moved across a writing surface.

### DETAILED DESCRIPTION

As indicated above, the present invention provides a writeable display medium with faster image updates. The invention is made possible by incorporating light-sensitive semiconductors into the thin film transistors (TFTs) that are used to control an image state for an electrophoretic medium, and incorporating a long-pass optical filter to provide a narrow window of wavelengths that can be used to cause the TFTs to switch states. As a light-emitting stylus is moved over the display, the light will change the state of the TFTs, resulting in a nearly instantaneous state change in the display (i.e., white to black). Accordingly, writeable display media of the invention will not suffer from the writing latency that is experienced with most writeable tablet systems. Furthermore, at the same time the stylus is causing a change in the display state, a separate electromagnetic (or capacitive) digitizing system is used to record the position of the stylus so that the writing can be recorded electronically and transformed into an electronic image file.

The invention is intended to be used with electrophoretic media of the type developed by E Ink Corporation (Billerica, Mass.) and described in the patents and patent publications listed below. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include: (a) Electrophoretic particles, fluids and fluid additives; see for example U.S. Pat. Nos. 7,002,728 and 7,679,814; (b) Capsules, binders and encapsulation processes; see for example U.S. Pat. Nos. 6,922,276 and 7,411,719; (c) Microcell structures, wall materials, and methods of forming microcells; see for example U.S. Pat. Nos. 7,072,095 and 9,279,906; (d) Methods for filling and sealing microcells; see for example U.S. Pat. Nos. 7,144,942 and 7,715,088; (e) Films and sub-assemblies containing electro-optic materials; see for example U.S. Pat. Nos. 6,982,178 and 7,839,564; (f) Backplanes, adhesive layers and other auxiliary layers and methods used in displays; see for example U.S. Pat. Nos. D485,294; 6,124,851; 6,130,773; 6,177,921; 6,232,950; 6,252,564; 6,312,304; 6,312,971; 6,376,828; 6,392,786; 6,413,790; 6,422,687; 6,445,374; 6,480,182; 6,498,114; 6,506,438; 6,518,949; 6,521,489; 6,535,197; 6,545,291; 6,639,578; 6,657,772; 6,664,944; 6,680,725; 6,683,333; 6,724,519; 6,750,473; 6,816,147; 6,819,471; 6,825,068; 6,831,769; 6,842,167; 6,842,279; 6,842,657; 6,865,010; 6,873,452; 6,909,532; 6,967,640; 6,980,196; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,280,094; 7,301,693; 7,304,780; 7,327,511; 7,347,957; 7,349,148; 7,352,353; 7,365,394; 7,365,733; 7,382,363; 7,388,572; 7,401,758; 7,442,587; 7,492,497; 7,535,624; 7,551,346; 7,554,712; 7,583,427; 7,598,173; 7,605,799; 7,636,191; 7,649,674; 7,667,886; 7,672,040; 7,688,497; 7,733,335; 7,785,988; 7,830,592; 7,843,626; 7,859,637; 7,880,958; 7,893,435; 7,898,717; 7,905,977; 7,957,053; 7,986,450; 8,009,344; 8,027,081; 8,049,947; 8,072,675; 8,077,141; 8,089,453; 8,120,836; 8,159,636; 8,208,193; 8,237,892; 8,238,021; 8,362,488; 8,373,211; 8,389,381; 8,395,836; 8,437,069; 8,441,414; 8,456,589; 8,498,042; 8,514,168; 8,547,628; 8,576,162; 8,610,988; 8,714,780; 8,728,266; 8,743,077; 8,754,859; 8,797,258; 8,797,633; 8,797,636; 8,830,560; 8,891,155; 8,969,886; 9,147,364; 9,025,234; 9,025,238; 9,030,374; 9,140,952; 9,152,003; 9,152,004; 9,201,279; 9,223,164; 9,285,648; and 9,310,661; and U.S. Patent Applications Publication Nos. 2002/0060321; 2004/0008179; 2004/0085619; 2004/0105036; 2004/0112525; 2005/0122306; 2005/0122563; 2006/0215106; 2006/0255322; 2007/0052757; 2007/0097489; 2007/0109219; 2008/0061300; 2008/0149271; 2009/0122389; 2009/0315044; 2010/0177396; 2011/0140744; 2011/0187683; 2011/0187689; 2011/0292319; 2013/0250397; 2013/0278900; 2014/0078024; 2014/0139501; 2014/0192000; 2014/0210701; 2014/0300837; 2014/0368753; 2014/0376164; 2015/0171112; 2015/0205178; 2015/0226986; 2015/0227018; 2015/0228666; 2015/0261057; 2015/0356927; 2015/0378235; 2016/077375; 2016/0103380; and 2016/0187759; and International Application Publication No. WO 00/38000; European Patents Nos. 1,099,207 B1 and 1,145,072 B1; (g) Color formation and color adjustment; see for example U.S. Pat. Nos. 7,075,502 and 7,839,564; and (h) Methods for driving displays; see for example U.S. Pat. Nos. 7,012,600 and 7,453,445. All of the patents and patent applications listed herein are incorporated by reference in their entirety.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

While the invention is primarily directed to electrophoretic media of the type described above and in the listed patents and patent applications, other types of electro-optic materials may also be used in the present invention. The alternative electro-optic media are typically reflective in nature, that is, they rely on ambient lighting for illumination instead of a backlight source, as found in an emissive LCD display. Alternative electro-optic media include rotating bichromal member type media as described, for example, in U.S. Pat. Nos. 5,808,783; 5,777,782; 5,760,761; 6,054,071 6,055,091; 6,097,531; 6,128,124; 6,137,467; and 6,147,791. Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another alternative electro-optic display medium is electrochromic, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and. Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

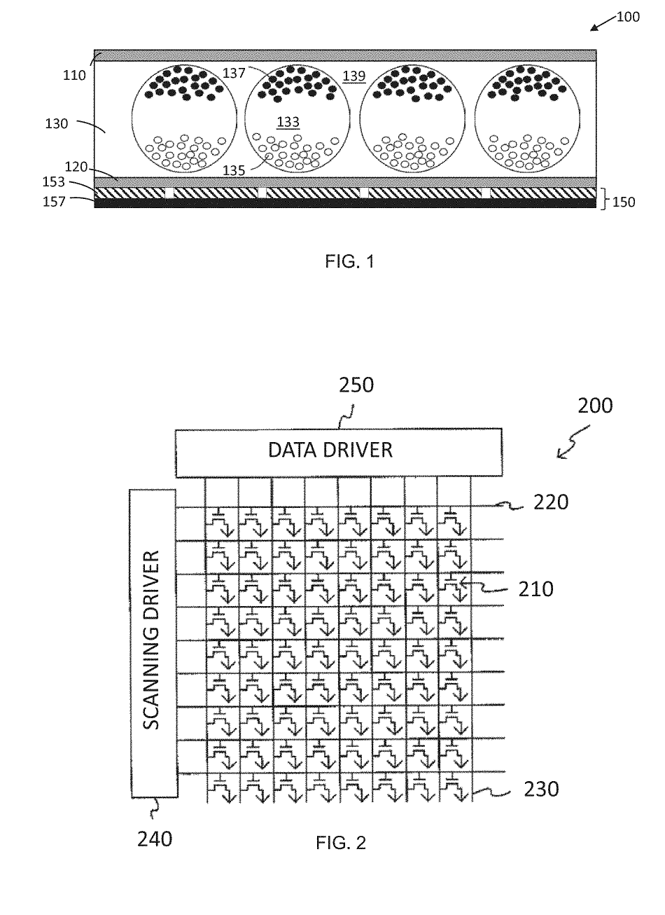

An exemplary electrophoretic display (EPID) is show in FIG. 1. Display 100 normally comprises a layer of electrophoretic material 130 and at least two other layers 110 and 120 disposed on opposed sides of the electrophoretic material 130, at least one of these two layers being an electrode layer, e.g., as depicted by layer 110 in FIG. 1. The front electrode 110 may represent the viewing side of the display 100, in which case the front electrode 110 may be a transparent conductor, such as Indium Tin Oxide (ITO) (which in some cases may be deposited onto a transparent substrate, such as polyethylene terephthalate (PET)). Such EPIDs also include, as illustrated in FIG. 1, a backplane 150, comprising a plurality of driving electrodes 153 and a substrate layer 157. The layer of electrophoretic material 130 may include microcapsules 133, holding electrophoretic pigment particles 135 and 137 and a solvent, with the microcapsules 133 dispersed in a polymeric binder 139. Nonetheless, it is understood that the electrophoretic medium (particles 135 and 137 and solvent) may be enclosed in microcells (microcups) or distributed in a polymer without a surrounding microcapsule (e.g., PDEPID design described above). Typically, the pigment particles 137 and 135 are controlled (displaced) with an electric field produced between the front electrode 110 and the pixel electrodes 153. In many conventional EPIDs the electrical driving waveforms are transmitted to the pixel electrodes 153 via conductive traces (not shown) that are coupled to thin-film transistors (TFTs) that allow the pixel electrodes to be addressed in a row-column addressing scheme. In some embodiments, the front electrode 110 is merely grounded and the image driven by providing positive and negative potentials to the pixel electrodes 153, which are individually addressable. In other embodiments, a potential may also be applied to the front electrode 110 to provide a greater variation in the fields that can be provided between the front electrode and the pixel electrodes 153.

In many embodiments, the TFT array forms an active matrix for image driving, as shown in FIG. 2. For example, each pixel electrode (153 in FIG. 1) is coupled to a thin-film transistor 210 patterned into an array, and connected to elongate row electrodes 220 and elongate column electrodes 230, running at right angles to the row electrodes 220. In some embodiments, one electrode layer has the form of a single continuous electrode and the other electrode layer is patterned into a matrix of pixel electrodes, each of which defines one pixel of the display. As shown in FIG. 2, the data driver 250 is connected to the column electrodes 230 and provides source voltage to all TFTs in a column that are to be addressed. The scanning driver 240 is connected to the row electrodes 220 to provide a bias voltage that will open (or close) the gates of each TFT along the row. The gate scanning rate is typically ˜60-100 Hz. Taking the gate-source voltage positive allows the source voltage to be shorted to the drain. Taking the gate negative with respect to the source causes the drain source currents to drop and the drain effectively floats. Because the scan driver acts in a sequential fashion, there is typically some measurable delay in update time between the top and bottom row electrodes. It is understood that the assignment of “row” and “column” electrodes is somewhat arbitrary and that a TFT array could be fabricated with the roles of the row and column electrodes interchanged.

While EPID media are described as “black/white,” they are typically driven to a plurality of different states between black and white to achieve various tones or “greyscale.” Additionally, a given pixel may be driven between first and second grayscale states (which include the endpoints of white and black) by driving the pixel through a transition from an initial gray level to a final gray level (which may or may not be different from the initial gray level). The term “waveform” will be used to denote the entire voltage against time curve used to effect the transition from one specific initial gray level to a specific final gray level. Typically, such a waveform will comprise a plurality of waveform elements; where these elements are essentially rectangular (i.e., where a given element comprises application of a constant voltage for a period of time); the elements may be called “pulses” or “drive pulses.” The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible to use more than one drive scheme simultaneously in different areas of the same display, and a set of drive schemes used in this manner may be referred to as “a set of simultaneous drive schemes.”

The manufacture of a three-layer electrophoretic display normally involves at least one lamination operation. For example, in several of the aforementioned patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane (see FIG. 1), containing an array of pixel electrodes and an appropriate arrangement of conductors to connect the pixel electrodes to drive circuitry (see FIG. 2), is prepared. To form the final display, the substrate having the capsule/binder layer thereon is laminated to the backplane using a lamination adhesive. In embodiments where it is desired to have additional layers, such as a digitizing sensor layer (Wacom Technologies, Portland, Oreg.), those layers may be inserted between the electrode layer and the substrate, or an additional substrate may be added between the electrode layer and the additional layer. In one preferred embodiment, the backplane is itself flexible and is prepared by printing the pixel electrodes and conductors on a plastic film or other flexible substrate. The lamination technique for mass production of displays by this process is roll lamination using a lamination adhesive.

During the lamination process, one or more lamination adhesives are used to provide mechanical continuity to the stack of components and also to assure that the layers are relatively planar with respect to each other. In some instances commercial lamination adhesives (lamad) can be used, however, manufacturers of lamination adhesives (naturally) devote considerable effort to ensuring that properties, such as strength of adhesion and lamination temperatures, while ignoring the electrical properties of the lamination adhesive. Accordingly, manufactures of electrophoretic displays typically modify commercial adhesives to achieve the needed volume resistivity. Methods for modifying the electrical properties of commercial adhesives are described in several of the before mentioned patents. The methods typically involve adding charged copolymers, charged moieties, or conductive particles. Because electrophoretic manufacturers are experienced in doping lamination adhesive layers, it is expected that adding additional components to tune the optical characteristics, e.g., to make a long pass filtering lamination adhesive layer, will be straightforward. For example, to reduce transmission of wavelengths shorter than 550 nm, a lamination adhesive can be doped with anthraquinone compounds, such as 1-methylamino anthraquinone. It is also possible to incorporate a mixture of additives to tune the low pass filter such that the combination of the absorption spectrum of the TFT materials and the absorption spectrum of the additives result in a narrow window of optical wavelengths, substantially overlapping with the output of the light emitting elements incorporated into the stylus. The efficacy of a filter is often measured in terms of optical density (O.D.) where optical density is defined as the base-ten logarithm of the ratio of the radiation that falls on a material over the radiation that is transmitted through the material. The low pass filters of the invention typically have an optical density of 0.4 or greater from 400 to 550 nm, for example and O.D. of 1 or greater from 400 to 550 nm, for example an O.D. of 2 or greater from 400 to 550 nm.

The light-sensitivity of thin-film transistors (TFTs) constructed from doped amorphous silicon has been known for some time. Amorphous silicon (a-Si) has a broad absorption spectrum from about 350-700 nm, with a peak absorption at around 500 nm. Because of this absorption spectrum, sunlight can cause small amounts of photocurrent in a-Si TFTs. The photocurrents can create unwanted features in images. As shown in FIG. 3, the light-sensitivity can be addressed by adding a passivation layer 310 to the TFT. As shown in FIG. 3, a TFT backplane 300 includes a passivation layer 310 to protect the boron-doped amorphous silicon layer(s) 320 from certain wavelengths. The passivation layer 310 may be made from silicon nitride and is easily deposited over the backplane structure after the electrodes 330 have been laid down. Further details for configuring backplanes for EPID applications can be found in U.S. Pat. No. 6,683,333, incorporated herein by reference in its entirety.

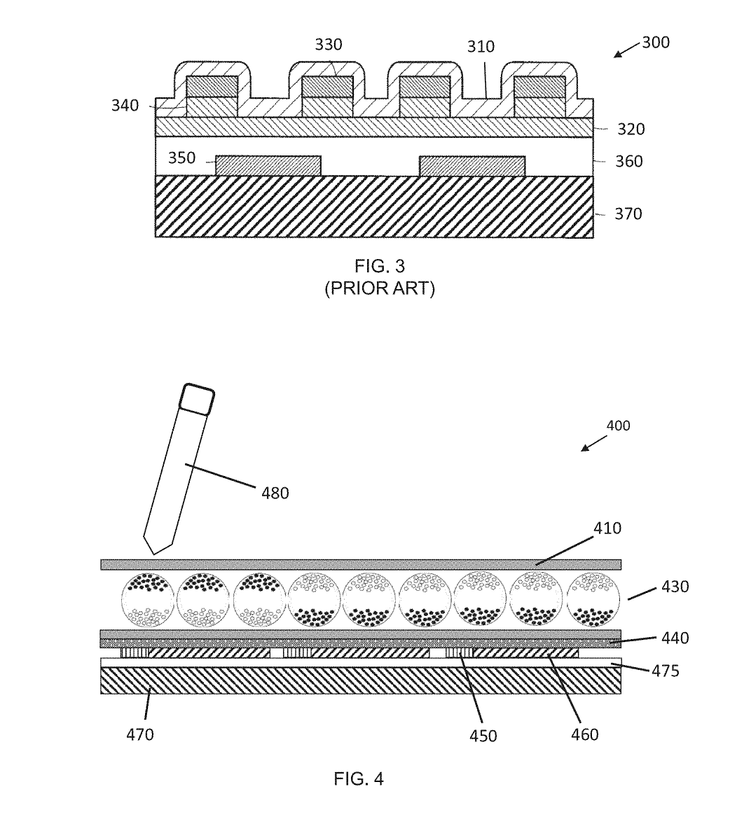

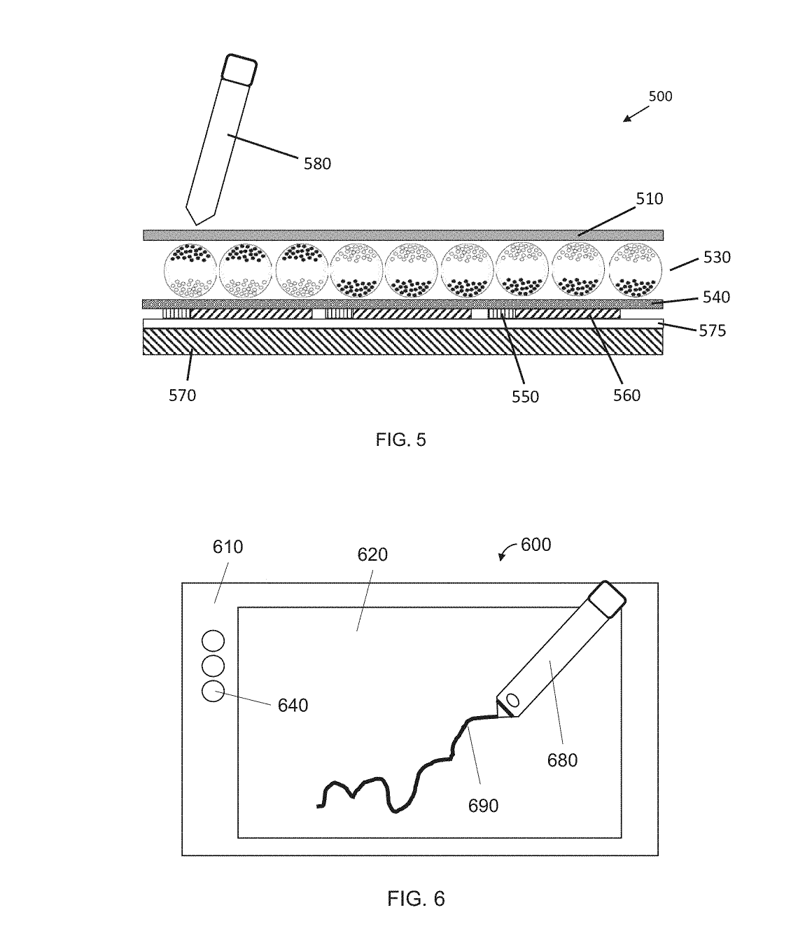

In the writeable display media of the invention, the passivation layer is replaced with a long-pass optical filter 440, as shown in FIGS. 4 and 5. When one or more TFTs 450 in the array is properly biased, a light emitting stylus 480 (described below) will thus cause a state change in a biased TFT 450, thereby causing the associated pixel electrode 460 to obtain an electrical potential sufficient to change the stage of the electrophoretic media 430 associated with the pixel electrode 460. The state change in the TFT will result in the electrophoretic medium changing from one state to the other (e.g., from white to black) which will appear to the user as writing/drawing on the display. The biasing of the TFTs is accomplished by electrical connections to the scan and data drivers, however the electrical connections are not shown in FIG. 4. In some embodiments, the long-pass optical filter 440 is a wavelength absorbing or wavelength reflecting film. In alternative embodiments, the absorptive or reflective materials providing the wavelength selection for the long pass optical filter 440 may be added directly to the lamination adhesive 540 to create a long pass lamination adhesive, as shown in FIG. 5. For example, the lamination adhesive 540 may include an amount of dye or pigment that will absorb the shorter wavelengths of light (yellow to blue), while not interfering with the transmission of longer wavelengths (e.g., red or infrared). The incorporation of the long pass materials into the lamination adhesive 540 reduces the number of processing steps for the backplane and allows for a thinner stack of materials (front plane laminate) thereby allowing for faster switching of the electrophoretic medium 530. Suitable pigments include, for example, magenta and yellow pigments, such as Ink Jet Magenta E 02 (available from Clariant Corporation) and Novoperm Yellow P M3R (Clariant Corporation). Of course, pigments and/or dyes can be combined to achieve an adhesive with the desired long-pass characteristics. In some embodiments, the lamination adhesive comprises between 0.1% and 20% (wt/wt) of pigment andlor dye in the lamination adhesive. In sonic embodiments, the lamination adhesive comprises between 1% and 10% (wt/wt) of pigment and/or dye in the lamination adhesive. In some embodiments, the lamination adhesive comprises between 2% and 5% (wewt) of pigment and/or dye in the lamination adhesive. The lamination adhesive may be a polyurethane lamination adhesive.

As shown in FIGS. 4 and 5, a digitizing layer 475/575 can be added to the assembly to track the position of the stylus 480/580. Because the stylus 480/580 includes an inductive coil, the motion of the stylus interacts with the electromagnetic fields produced by the digitizing layer 475/575, allowing the digitizing layer to determine a position in the X-Y plane defined by the digitizing layer. The digitizing layer 475/575 is typically coupled to memory so that the movement of the stylus 480/580 can be recorded in an electronic file, whereby the electronic file may be printed, converted into a .pdf document, e-mailed, etc. Furthermore, the electronic file may be the basis for a global update to the image, e.g., via the display driver, after some amount of writing has been completed.

Writeable display media of the invention may be incorporated into a writeable system 600, such as shown in FIG. 6. The writeable system includes a writeable display medium 620 (discussed above with respect to FIGS. 4 and 5), and a stylus 680 that includes a light source and that is configured to interact with the digitizing layer. As shown in FIG. 6, the writeable system 600 resembles a conventional electronic writeable tablet, including a housing 610 and interfacial controls 640 which can be real or virtual. That is, the interfacial controls 640 can be separate buttons, dials, etc., or the interfacial controls 640 can be generated by the operating software and displayed/interfaced through the display. As discussed previously, the stylus 680 produces light that is not substantially blocked by the long pass filter, but the wavelength is appropriate to prompt photocurrents in a biased TFT. For example, the stylus may include a light emitting diode or a laser that produces light between 600-900 nm, for example, light between 600-700 nm, for example between 650 and 700 nm. Suitable light sources are Fabry-Perot-type laser diodes, which can be obtained from suppliers such as Newport Corporation (Irvine, Calif.) with center wavelengths of 660 nm or 680 nm. Other light sources, such as high-intensity red LEDs are available from a variety of suppliers such as DigiKey (Thief River Falls, Minn.).

As a user “writes” with the stylus 680 on the writeable medium 620, the light emitted from the tip of the stylus 680 will pass through the light-transmissive front electrode 410, the electrophoretic medium 430, and the long pass filter 440, and strike one or more thin film transistors 450 that have been biased to accept the light-writing. When the TFTs are irradiated with the proper wavelength, the photocurrent will be sufficient to cause a state change in the TFT 450, which increases (or decreases depending upon need) the electrical potential on the pixel electrode 460, whereupon the electrophoretic medium 430 will switch (e.g., from white to black) the display where the stylus 680 has been. The resultant graphic 690 will appear on the writeable medium 620 in about 20 ms because, unlike prior art tablets, there is no signal processing required to create the pattern under the stylus 680. That is, the stylus is directly opening (or closing) the gates of the TFTs, thus the “latency” is merely the time that it takes for the electrophoretic particles to respond to the new electrical potential.

During light-writing, a display controller will instruct the scanning driver to set all gate voltages (V_{G}) at a negative voltage while the data driver sets all source voltages (Vs) to a high positive value. See FIG. 2. The high voltage will typically correspond to the driving voltage for a state change, while the exact negative value of V_{G} will depend on the choice of TFT materials, and the light source used in the stylus. At the same time the gate voltages are negative and the source voltage is high, all of the drains of the TFTs (V_{D}) will be floated. Once in this state, the user can address the display with the light-emitting stylus. As the stylus is passed over the display it will irradiate the gates of various TFTs under the stylus. The resulting photo-current in the gate will cause the source and drain terminals of the TFT to be shorted, which will bring the pixel electrode voltage to the high positive value (e.g., 15 V). Once the pixel electrode switches to the high positive value, the positively-charged black electrophoretic particles will be driven away from the pixel electrode and toward the light transmissive top electrode, making the appearance of a line. Of course, if desired, the display could be “blacked out” and the stylus used to “write” white features if the voltages are switched. Furthermore, in electrophoretic systems having more than two types of particles, lines can be made to appear, corresponding to desired particle sets, e.g., accent colors, by choosing the appropriate initial voltage for the source voltage.

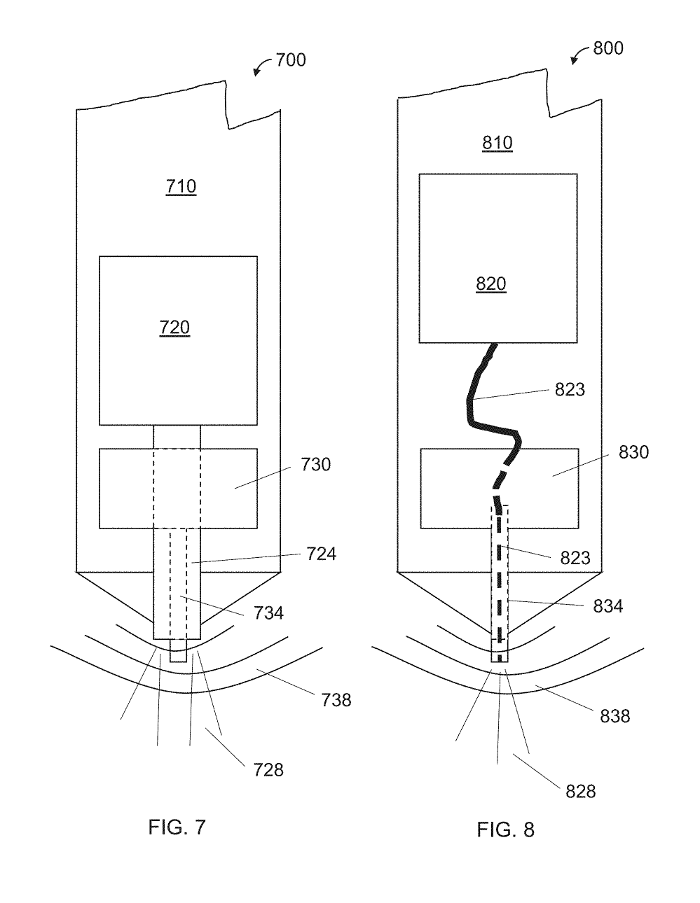

In most embodiments, the light-writing will be complemented by a conventional electromagnetic or capacitive digitizer that will track the position of the stylus. This configuration will allow the “writing” to be recorded at the same time the writeable display 620 is updated with the graphic 690. Exemplary stylus designs that provide both a light source and a mechanism for tracking the motion of the stylus are shown in FIGS. 7 and 8. FIG. 7 shows a cut-away of the tip of a light and electromagnetic induction (EMR) capable stylus 700. The stylus comprises a body 710 which is held by the user and which houses the electrical components needed for functionality. A light source 720 may be an LED or a diode laser. Other laser sources may be used, however, the size and the shape of the stylus may vary with requirements for an optical cavity and lasing medium. The light source 720 is directly coupled to a sheath 724 that provides a light path from the light source 720 to the tip, where the light 728 is emitted. The tip of stylus 700 additionally includes an inductive coil 734 that is coupled to electronics 730 that allow the electromagnetic flux created during motion to be tracked and broadcast back 738 to the digitizing layer. As shown in FIG. 7, the light sheath 724 surrounds the inductive coil, thus allowing the coil and the light to be focused at approximately the same position.

An alternative stylus construction, achieving the same performance, is shown in FIG. 8. In FIG. 8, the light is channeled through an optical fiber 823 that travels within the inductive coil 834, thereby allowing the light 828 to exit the stylus 800 at the tip. It is understood that other designs that deliver light and allow for electronic sensing would also be suitable. For example, a stylus could use a capacitive touch element in the tip, and the writeable device could use a capacitive touch screen to sense the position of the pen during the “writing.” A stylus to be used with the invention may include other additional elements, such as a power supply (e.g., a battery), BLUETOOTH® communication, a button, and an eraser at the end of the stylus opposing the tip. Typically, the eraser will work with the same functionality as the digitizer.

Because the stylus incorporates both light-writing and electromagnetic (or capacitive) sensing, it is possible to write in multiple modes. For example, if a user only wants to make a design or note, the system can be switched to a mode in which all of the TFTs are biased and the stylus merely switches the states of the electrophoretic ink as the stylus is passed over. In this mode, the device works much like a BOOGIEBOARD® (Kent Displays, Kent Ohio), it is capable of writing fast, but there is no way to save the design or convert to text, etc. In another mode, the system will employ both the light source and the digitizer, providing nearly instant writing updates while also saving the stylus positions electronically for later reference. In yet another mode, the light may be deactivated and none of the TFTs biased so that the writeable system works similar to many writeable tablets currently available. This “no light” mode may be useful when taking notes on an electronic document because the user does not necessarily want to “flip” the state of the pixels, but rather make marks in the correct location. In an embodiment of the “no light” mode, the difference between the gate and source voltages (V_{GS}) of the TFTs of the device would be set at a large negative value, thereby assuring that even if the light from the stylus was shown onto the display, there would be no change in the display state.

In advanced embodiments, the writing modes are likely to be more complex. The algorithms for displaying and recording the writing need to account for other factors beyond the position of the stylus. For example advanced algorithms may account for the user's hand position, the ambient lighting conditions, and the existence of previous images on the display. In some embodiments, it will be beneficial to reduce the number of TFTs that are biased to allow for light-writing to a number smaller than the entirety of the TFT array. That is, during the writing only the TFTs in the vicinity of the stylus will be biased and available for light-writing.

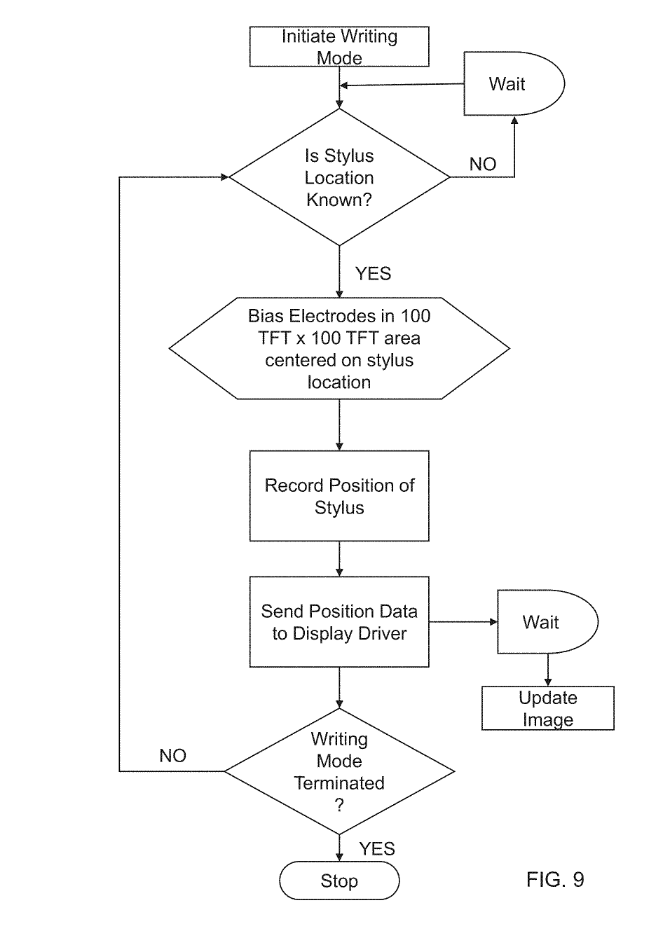

A method for updating the display of a writeable system with a localized number of biased TFTs is shown in FIG. 9. The method begins with the user initiating a writing mode, whereupon the digitizer will determine the position of the stylus. Once the position of the stylus is known, a number of TFTs will be biased to allow their states to be switched by the light emitted from the stylus. As shown in FIG. 9, the biased area is a 100 TFT by 100 TFT area, however a larger or smaller number of TFTs could be used depending upon the needs of the user and the application. For example, if the writeable device has large pixels and lower resolution, it may appropriate to only bias a 10 TFT by 10 TFT area. Once the TFTs are biased, any of the TFTs can be “written” by the stylus. As described above, the motion of the stylus will be captured on the display nearly instantaneously. However, at the same time that the stylus is causing state switching in the biased TFTs, the position of the stylus is also being recorded by the digitizer, saved to memory, and ultimately sent to the display driver. The delay between when the position data is received by the display driver and when the image is updated is arbitrary, and may be set by the user depending upon preference. In some instances, the display driver will dynamically update the display by removing the bias on the TFTs and returning them to their “proper” state depending upon the digitizer-recorded position of the stylus. That is, after an area has been written with the stylus, and the light from the stylus causes a switch in the state of the electrophoretic medium, the entire area will be refreshed so that the image matches what was recorded by the digitizer. Additional corrections, such as smoothing and text correction, may also be performed on the recorded positions of the stylus. Accordingly, the system allows for a fast optical response to stylus writing but also records the writing so that it can be stored electronically and shared. For example, in some embodiments, the display controller will detect when the pen breaks contact with the display and refresh the screen.

### Definitions

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” or “gray scale” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the teen “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

### EXAMPLE

Samples of active matrix backplanes were fabricated with thin-film-transistor (TFT) gate masks removed (E Ink Holdings, Hsinchu, Taiwan). (Normally, a gate mask is provided to prevent spurious opening of transistors by higher energy photons, e.g., from direct sunlight). A polyurethane lamination adhesive was prepared with approximately 3% (wt/wt) of a dispersed functionalized quinacridone pigment described in U.S. Pat. No. 9,752,034, which is incorporated herein by reference in its entirety. A slurry of capsules including black and white electrophoretic pigments in a hydrocarbon solution were prepared using the methods that are described in the patents above. The slurry was coated onto a sheet of PET-ITO (Saint Gobain) and conditioned at the desired temperature and humidity. After conditioning, the capsules were overcoated with the lamination adhesive including the quinacridone pigment, and the resulting front plane laminate was laminated to the active matrix without the gate masks to produce a light-sensitive writeable display that only respond to longer wavelengths of visible light.

The resulting displays were driven with standard electrophoretic display controllers (EVK3-6SL/TPS, E Ink Corporation), and showed standard gray-scale test patterns when driven with the proper waveforms. The display was then set to “write mode” by setting the VEE value to −22V and the VCOM to −15V. The scanning of the gate lines was turned off in this “write mode”.

Once in “write mode” the pixel array could be addressed instantaneously with a red diode laser pointer (650 nm; approximately 1 mW). However, a green laser pointer (532 nm) with over 10× the intensity (˜12 mW) did not address the pixel array in “write mode”, confirming that the addressing was strongly wavelength-dependent. Furthermore, no switching was observed when the writeable display was put in “write mode” and exposed to direct sunlight for 30 minutes. Once the “write mode” was turned off the display returned to normal switching when fed the desired waveforms from the controller.

From the foregoing, it will be seen that the present invention can provide a writeable electro-optic display medium and a light-emitting stylus for causing a nearly instantaneous update of a display controlled by light-sensitive thin film transistors. It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A writeable display medium comprising:
a light-transmissive front electrode;
an electrophoretic medium comprising charged particles that move in the presence of an electric field;
an array of thin film transistors comprising light-sensitive semiconductors;
a long pass optical filter; and
a digitizing layer configured to locate a touch on the writeable display medium.

2. The writeable display medium of claim 1, further comprising a power source and a display driver, both operatively coupled to the array of thin film transistors.

3. The writeable display medium of claim 2, further comprising memory operatively coupled to the digitizing layer and the display driver, and memory configured to receive position information from the digitizing layer and to send the position information to the display driver.

4. The writeable display medium of claim 2, wherein the display driver is coupled to the array of thin film transistors with source lines and gate lines.

5. The writeable display medium of claim 1, wherein the long pass optical filter is incorporated into an adhesive layer.

6. The writeable display of claim 5, wherein the adhesive layer comprises a light-absorbing dye or pigment.

7. The writeable display medium of claim 5, wherein the adhesive layer comprises an additive that absorbs light between 400 and 550 nm.

8. The writeable display medium of claim 1, wherein the long pass optical filter reflects light between 400 and 550 nm.

9. The writeable display medium of claim 1, wherein the long pass optical filter has an optical density of at least 0.5 for the range of 400-550 nm.

10. The writeable display medium of claim 9, wherein the long pass optical filter has an optical density of at least 1 for the range of 400-550 nm.

11. The writeable display medium of claim 1, wherein the light-sensitive semiconductors comprise amorphous silicon.

12. The writeable display medium of claim 1, wherein the light-sensitive semiconductors experience a photocurrent when exposed to light with wavelengths from 600-900 nm.

13. The writeable display medium of claim 1, wherein the digitizing layer uses electromagnetic sensing to determine the position of a touch.

14. The writeable display medium of claim 1, wherein the digitizing layer uses capacitive sensing to determine the position of a touch.

15. A writeable system comprising:
a writable display medium including:
a light-transmissive front electrode,
an electrophoretic medium comprising charged particles that move in the presence of an electric field,
an array of thin film transistors comprising light-sensitive semiconductors, a long pass optical filter, and
a digitizing layer configured to locate a touch on the writeable display medium; and
a stylus including a light source and configured to interact with the digitizing layer.

16. The writeable system of claim 15, further comprising a power source and a display driver operatively coupled to the array of thin film transistors.

17. The writeable system of claim 16, further comprising memory operatively coupled to the digitizing layer and the display driver, and configured to receive position information from the digitizing layer and then send the position information to the display driver.

18. The writeable system of claim 16, wherein the power source is operatively coupled to the digitizing layer.

19. The writeable system of claim 15, wherein the light source produces light between 600 and 900 nm.

20. The writeable system of claim 19, wherein the light source comprises a light-emitting diode or a laser.

21. A method for switching the state of an electrophoretic display, comprising:
providing an electrophoretic display including a light-transmissive electrode, an array of thin film transistors comprising light-sensitive semiconductors, an electrophoretic medium comprising charged particles that move in the presence of an electric field, and a long pass filter, wherein the electrophoretic medium is sandwiched between the light-transmissive electrode and the array of thin film transistors;
biasing thin film transistors (TFTs) of the array so that the thin film transistor will cause the electrophoretic medium to switch states when the electrophoretic display is exposed to light; and
exposing the electrophoretic display to a light source, thereby causing the electrophoretic display to switch states.

22. The method of claim 21, further comprising:
sensing a position of the light source in an X-Y plane defined by the array of thin film transistors and biasing thin film transistors within a 10 TFT×10 TFT square centered on the position of the light source.

23. The method of claim 22, comprising biasing thin film transistors within a 100 TFT×100 TFT square centered on the position of the light source.

24. The method of claim 21, further comprising recording the position of the light source in an X-Y plane defined by the array of thin film transistors, and writing the position to memory.

25. The method of claim 24, further comprising:
sending the position of the light source to a display driver;
clearing an image on the electrophoretic display;
sending image data from the display driver to the thin film transistor array, wherein
the image data represents the recorded position of the light source; and
displaying the image data on the electrophoretic display.
